(19) United States
(12) Patent Application Publication
(10) Pub. No.: US 2006/0170641 A1
(43) Pub. Date: Aug. 3, 2006

(54) Driving apparatus for liquid crystal display and liquid crystal display including the same

(75) Inventors: Seock-Cheon Song, Seoul (KR); Keun-Woo Park, Gangnam-gu (KR); Sang-Hoon Lee, Seoul (KR); Pil-Mo Choi, Seoul (KR); Ung-Sik Kim, Suwon-si (KR)

Correspondence Address: F. CHAU & ASSOCIATES, LLC, 130 WOODBURY ROAD, WOODBURY, NY, 11797, US

(73) Assignee: Samsung Electronics CO., LTD., Suwon-si (KR)

(21) Appl. No.: 11/328,764

(22) Filed: Jan. 10, 2006

(30) Foreign Application Priority Data
Feb. 2, 2005 (KR) 10-2005-0009507

(51) Int. Cl. G09G 3/36

(52) U.S. Cl. 345/98

(57) ABSTRACT

A driving apparatus for a liquid crystal display, including a signal line transmitting a gate voltage, a gate voltage generator generating the gate voltage, a switching unit disposed between the gate voltage generator and a gate voltage line, and a signal controller generating a control signal for control of the switching unit.

### CROSS-REFERENCE TO RELATED APPLICATION

This application claims priority from Korean Patent Application No. 10-2005-0009507 filed on Feb. 2, 2005, in the Korean Intellectual Property Office, the disclosure of which is incorporated by reference herein in its entirety.

### BACKGROUND OF THE INVENTION

1. Field of the Invention

The present invention relates to a driving apparatus for a liquid crystal display and a liquid crystal display including the same.

2. Description of Related Art

Typically, a liquid crystal display (LCD) includes a liquid crystal (LC) panel unit including two panels provided with pixel electrodes and common electrodes, and an LC layer with dielectric anisotropy interposed therebetween. The pixel electrodes are arranged in a matrix and are connected to switching elements such as thin film transistors (TFT) to be sequentially applied with a data voltage for a row. The common electrodes cover the entire surface of the upper panel and are supplied with a common voltage. A pixel electrode, a common electrode, and the LC layer form an LC capacitor in a circuital view, and the LC capacitor together with a switching element connected thereto is a basic unit of a pixel.

The LCD is device which displays images by applying an electric field to a liquid crystal layer disposed between two panels and regulating the strength of the electric field to adjust a transmittance of light passing through the liquid crystal layer. Meanwhile, for preventing the LC layer from deteriorating due to a one-directional electric field, the polarity of the data voltage is reversed for each frame, for each row, or for each dot with respect to the common voltage, or the polarities of the data voltage and the common voltage are reversed together.

The LCD, as a small and medium sized display device, is used with a dual display device which has panel units in each of its inner and outer sides.

The dual display device includes a main panel unit mounted on the inner side, a subsidiary panel unit mounted on the outer side, a driving flexible printed circuit film (FPC) provided with signal lines to transmit input signals from external devices, an auxiliary FPC connecting the main panel unit to the subsidiary panel unit, and an integration chip which controls the above-described elements.

The LCD includes a panel unit provided with pixels including switching elements and display signal lines, a gate driver providing a gate-on voltage and a gate-off voltage for gate lines of the display signal lines to turn on/off the switching elements, and a data driver providing a data signal for data lines of the display signal lines to apply a data voltage to the pixels via the turned-on switching elements, and the integration chip generates control signals and driving signals for controlling the main panel unit and the subsidiary panel unit, which is generally mounted as a chip-on-glass (COG). Additionally, the gate driver may be formed with the switching elements to be integrated on the edge of the panel unit. Additionally, the integration chip includes a gate voltage generator for supplying the gate-on voltage and the gate-off voltage to the gate driver.

Respective high voltage and low voltage lines are disposed at inner and outer sides along the edge of the panel unit in order to prevent electrostatic damage in the process of manufacturing the LCD. A diode unit including a plurality of diodes is connected between the high voltage line and the low voltage line, and the data lines are connected to the diode unit to release an electrostatic charge that penetrates into the center of the panel unit to the outside via a predetermined path, thereby protecting the panel unit.

The high and low voltage lines are connected between the integration chip and the gate driver, and transmit the gate-on voltage and the gate-off voltage, respectively, in a normal operation mode, e.g., for a mobile phone.

When power is supplied to the LCD, the gate voltage generator begins to generate the gate-on voltage and the gate-off voltage. A short time is taken to reach voltages in a steady state (hereinafter referred to as “steady voltage”). At this time, transitional voltages in a state of not reaching the steady voltages are transmitted to the high and low voltage lines, and the diodes, for example, two diodes connected between two voltage lines function as resistors to divide the transitional voltages. Thus, each of the data lines connected between the two diodes is applied with the divided voltage and thereby a current flows to the switching element of the pixel. A leakage current flows to the LC capacitor for being charged in a turned-off state of the switching element. The charged voltage in the LC capacitor activates the LC. Accordingly, vertical stripes along the data lines are displayed on a screen of the LCD or horizontal stripes along the gate lines are displayed thereon.

### SUMMARY OF THE INVENTION

A driving apparatus for a liquid crystal display is provided, including a signal line transmitting a gate voltage, a gate voltage generator generating the gate voltage, a switching unit disposed between the gate voltage generator and a gate voltage line, and a signal controller generating a control signal for control of the switching unit. The switching unit may be turned on after the gate voltage reaches a steady state.

The driving apparatus may further include a first capacitor having an end connected between the gate voltage generator and the switching unit and another end connected to a ground voltage, and a second capacitor having an end connected to the signal line and another end connected to a ground voltage. A capacitance of the first capacitor may be greater than a capacitance of the second capacitor. A ratio of the capacitance of the first capacitor and the capacitance of the second capacitor may be more than about 100:1.

The gate voltage generator may include a gate-on voltage generator generating a gate-on voltage and a gate-off voltage generator generating a gate-off voltage. The signal line may include a first voltage line transmitting the gate-on voltage and a second voltage line transmitting the gate-off voltage. The switching unit may include a first switching element connected to the gate-on voltage generator and a second switching element connected to the gate-off voltage generator.

The driving apparatus may further include a first capacitor having an end connected between the gate-on voltage generator and the first switching element and another end connected to a ground voltage, a second capacitor having an end connected between the gate-off voltage generator and the second switching element and another end connected to a ground voltage, a third capacitor having an end connected to the first voltage line and another end connected to a ground voltage, and a fourth capacitor having an end connected to the second voltage line and another end connected to a ground voltage.

The capacitance of the first capacitor and the capacitance of the second capacitor may be greater than the capacitance of the third capacitor and the capacitance of the fourth capacitor. A ratio of the capacitance of the first capacitor to the capacitance of the third capacitor, and a ratio of the capacitance of the second capacitor to the capacitance of the fourth capacitor may be more than about 100:1, respectively. The first and second switching elements may turn on after the first and second capacitors are charged.

The liquid crystal display includes a panel unit provided with a plurality of pixels having gate lines and data lines connected thereto, and, herein, the driving apparatus may further include a driving circuit driving the panel unit. The driving circuit may include the switching unit.

A liquid crystal display is also provided, including a plurality of pixels arranged in a matrix, a panel unit provided with gate lines and data lines connected to the pixels, a gate driver applying gate signals to the gate lines, a driving circuit applying data voltages to the data lines, a plurality of transmission gates connected between the data lines and the driving circuit, a first voltage line disposed in a ring along an edge of the panel unit, a second voltage line disposed in a ring along the edge of the panel unit and outer sides of the first voltage line, a first diode unit including a first diode group, which is disposed apart from the driving circuit and connected in series between the first and second voltage lines and is comprised of a plurality of diodes, a second diode unit including a second diode group, which is disposed close to the driving circuit and connected in series between the first and second voltage lines and is comprised of a plurality of diodes, a gate voltage generator generating a gate-on voltage and a gate-off voltage for applying to the gate driver via the first and second voltage lines, respectively, and first and second switching elements connected between the gate voltage generator and the first voltage line, and the gate voltage generator and the second voltage line, respectively.

An end of each of the data lines may be connected between the first diode group and another end thereof is connected to the second diode group via one of the plurality of transmission gates.

The liquid crystal display may further include a signal controller, a switching control signal thereof turning on/off the first and second switching elements.

The gate voltage generator may include a gate-on voltage generator generating a gate-on voltage and a gate-off voltage generator generating a gate-off voltage.

The liquid crystal display may further include a first capacitor having an end connected between the gate-on voltage generator and the first switching element and another end connected to a ground voltage, a second capacitor having an end connected between the gate-off voltage generator and the second switching element and another end connected to a ground voltage, a third capacitor having an end connected to the first voltage line and another end connected to a ground voltage, and a fourth capacitor having an end connected to the second voltage line and another end connected to a ground voltage.

A capacitance of the first capacitor and a capacitance of the second capacitor may be greater than a capacitance of the third capacitor and a capacitance of the fourth capacitor. A ratio of the capacitance of the first capacitor and the capacitance of the third capacitor may be more than about 100:1. A ratio of the capacitance of the second capacitor and the capacitance of the fourth capacitor may be more than about 100:1.

The first and second switching elements may turn on after the first and second capacitors are charged. The first and second diode groups may be connected in a backward direction. An end of each of the data lines may be connected between the first diode group and another end thereof is connected to the second diode group via one of the plurality of transmission gates.

The driving circuit may include the gate voltage generator, and may include the first and second switching elements. The driving circuit may include the signal controller.

### BRIEF DESCRIPTION OF THE DRAWINGS

The present invention will become more apparent by describing preferred embodiments thereof in detail with reference to the accompanying drawings in which:

FIG. 1 shows a schematic view of an LCD according to an exemplary embodiment of the present invention;

FIG. 2 is a block diagram of an LCD according to an exemplary embodiment of the present invention;

FIG. 3 illustrates a structure and an equivalent circuit diagram of a pixel of an LCD according to an exemplary embodiment of the present invention;

FIG. 4 shows a schematic view of an LCD according to an exemplary embodiment of the present invention;

FIG. 5 shows a partially enlarged view of the LCD of FIG. 4;

FIG. 6 shows an equivalent circuit diagram of a driving apparatus of an LCD according to an exemplary embodiment of the present invention; and

FIG. 7 is a timing chart of a gate-on voltage and a switching control signal of a driving apparatus of an LCD according to an embodiment of the present invention.

### DETAILED DESCRIPTION OF PREFERRED EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein.

In the drawings, the thickness of layers and regions are exaggerated for clarity. Like numerals refer to like elements throughout. It will be understood that when an element such as a layer, film, region, substrate, or panel is referred to as being “on” another element, it can be directly on the other element or intervening elements may also be present. In contrast, when an element is referred to as being “directly on” another element, there are no intervening elements present.

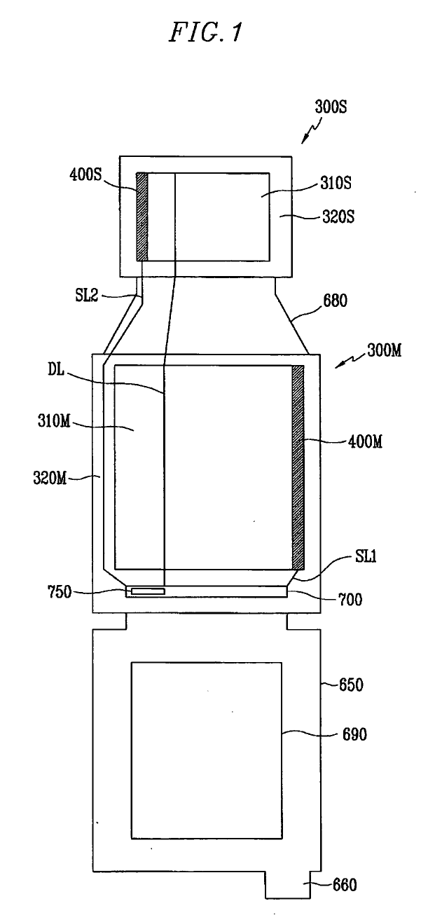

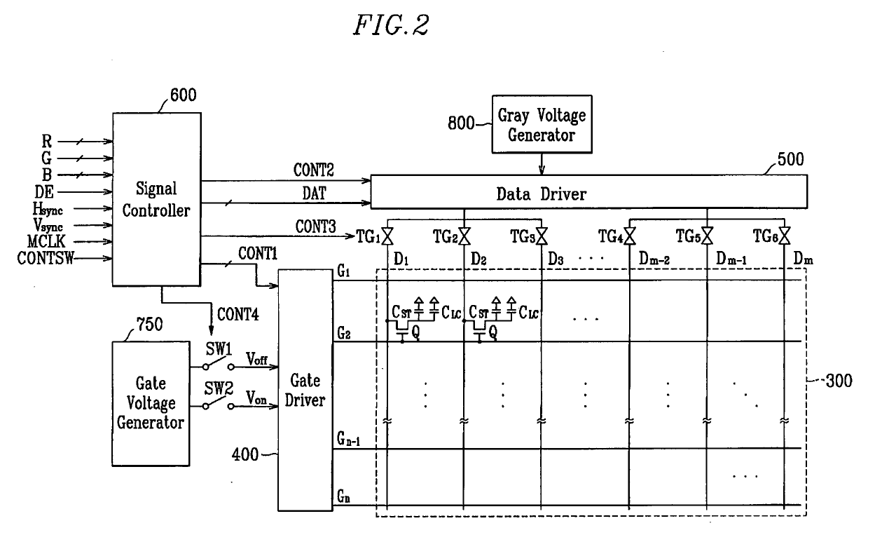

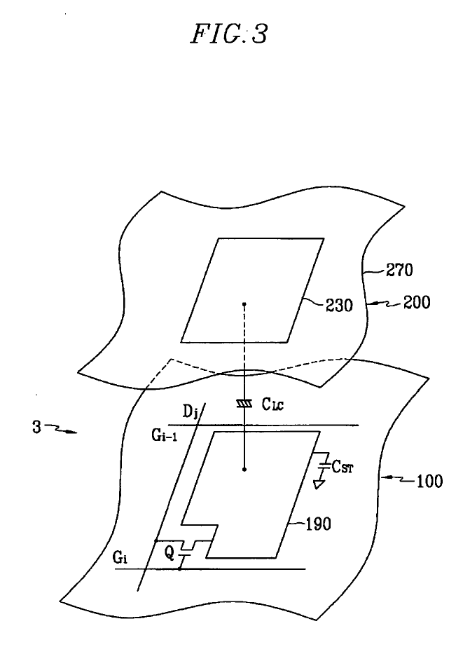

FIG. 1 shows a schematic view of an LCD according to an exemplary embodiment of the present invention, FIG. 2 is a block diagram of an LCD according to an embodiment of the present invention, and FIG. 3 shows an equivalent circuit diagram of a pixel of an LCD according to an embodiment of the present invention.

Referring to FIG. 1, an LCD according to an embodiment of the present invention includes two panel units of a main panel unit 300M and a subsidiary panel unit 300S, and an FPC 650 attached to the main panel unit 300M, an auxiliary FPC 680 attached between the main and the subsidiary panel units 300M and 300S, and an integration chip 700 mounted on the main panel unit 300M.

The FPC 650 is attached to one side of the mail panel unit 300M and has an opening 690 exposing the subsidiary panel unit 300S in a folded state.

The FPC 650 has a connector 660 where signals are input from an external device in the lower side thereof, and a plurality of signal lines (not shown) for electrically connecting the integration chip 700 to the panel units 300M and 300S. The signal lines form pads (not shown) in the connection points of the integration chip 700 and the attachment points of the panel units 300M and 300S by substantial enlargement thereof.

The auxiliary FPC 680 is attached between the other side of the main panel unit 300M and one side of the subsidiary panel unit 300S, and is provided with signal lines SL2 and DL for electrically connecting the integration chip 700 and the subsidiary panel unit 300S.

The panel units 300M and 300S include display areas 310M and 310S forming screens, and peripheral areas 320M and 320S, respectively. The peripheral areas 320M and 320S may include light-blocking layers (not shown) (“black matrix”) for blocking light. The FPCs 650 and 680 are attached to the light-blocking areas of the peripheral areas 320M and 320S.

As shown in FIG. 2, each of the panel units 300M and 300S includes a plurality of display signal lines including a plurality of gate lines G₁-Gₘ and a plurality of data lines D₁-Dₘ, a plurality of pixels connected thereto and arranged substantially in a matrix, and a gate driver 400 supplying signals to the gate lines. Most of the pixels and the display signal lines G₁-Gₙ and D₁-Dₘ are disposed in the display areas 310M and 310S, and the gate drivers 400M and 400S are located in the peripheral areas 320M and 320S. The peripheral areas 320M and 320S have lager widths where the gate drivers 400M and 400S are disposed.

Additionally, as shown in FIG. 1, portions of the data lines D₁-Dₘ are connected to the subsidiary panel unit 300S via the auxiliary FPC 680. That is, two panel units 300M and 300S share portions of the data lines D₁-Dₘ, and a line DL thereof is shown in FIG. 1.

The display signal lines G₁-Gₙ and D₁-Dₘ are provided on the lower panel 100 and include a plurality of gate lines G₁-Gₙ transmitting gate signals, called scanning signals, and a plurality of data lines D₁-Dₘ transmitting data signals. The gate lines G₁-Gₙ extend substantially in a row direction and they are substantially parallel to each other, while the data lines D₁-Dₘ extend substantially in a column direction and they are substantially parallel to each other. The pads of the FPC 650, the pads of the connectors 680M and 680S and the pads of each of the panel units 300M and 300S are electrically connected to each other using solder or an anisotropic conductive film (ACF).

Each pixel includes a pixel switching element Q connected to the display signal lines G₁-Gₙ and D₁-Dₘ, and an LC capacitor C_{LC} and a storage capacitor C_{ST} that are connected to the pixel switching element Q. The storage capacitor C_{ST} may be omitted.

The pixel switching element Q such as a TFT is provided on the lower panel 100 and has three terminals: a control terminal connected to one of the gate lines G₁-Gₙ; an input terminal connected to one of the data lines D₁-Dₘ; and an output terminal connected to the LC capacitor C_{LC} and the storage capacitor C_{ST}.

As shown in FIG. 3, the panel unit 300 includes the lower panel 100, the upper panel 200 and an LC layer 3 interposed therebetween. The display signal lines G₁-Gₙ and D₁-Dₘ and the pixel switching element Q are provided on the lower panel 100.

The LC capacitor C_{LC} includes a pixel electrode 190 provided on the lower panel 100, a common electrode 270 provided on the upper panel 200, and the LC layer 3 as a dielectric between the electrodes 190 and 270. The pixel electrode 190 is connected to the pixel switching element Q, and the common electrode 270 covers the entire surface of the upper panel 100 and is supplied with a common voltage Vcom. Alternatively, both the pixel electrode 190 and the common electrode 270, which have shapes of bars or stripes, may be provided on the lower panel 100.

The storage capacitor C_{ST} is an auxiliary capacitor for the LC capacitor C_{LC}. The storage capacitor C_{ST} includes the pixel electrode 190 and a separate signal line (not shown), which is provided on the lower panel 100, overlaps the pixel electrode 190 via an insulator, and is supplied with a predetermined voltage such as the common voltage Vcom. Alternatively, the storage capacitor C_{ST} includes the pixel electrode 190 and an adjacent gate line called a previous gate line, which overlaps the pixel electrode 190 via an insulator.

For color display, each pixel uniquely represents one of three primary colors such as red, green, and blue colors (spatial division), or sequentially represents the three primary colors in time (temporal division), thereby obtaining a desired color. FIG. 2 shows an example of the spatial division in which each pixel includes a color filter 230 representing one of the three primary colors in an area of the upper panel 200 facing the pixel electrode 190. Alternatively, the color filter 230 is provided on or under the pixel electrode 190 on the lower panel 100.

A pair of polarizers (not shown) for polarizing light is attached on outer surfaces of the lower and upper panels 100 and 200 of the panel unit 300.

A gate voltage generator 750 generates a gate-on voltage Von and a gate-off voltage Voff for application to the gate drivers 400M and 400S.

The gate drivers 400M and 400S synthesize the gate-on voltage Von and the gate-off voltage Voff to generate gate signals for application to the gate lines G₁-Gₙ. The gate drivers 400M and 400S are formed together with pixel switching elements Q to be integrated, and are connected to the integration chip 700 via signal lines SL1 and SL2, respectively.

The integration chip 700 is supplied with external signals via signal lines provided on the connector 660 and the FPC 650, and supplies processed signals for control of the main panel unit 300M and the subsidiary panel unit 300S thereto via signal lines provided on the peripheral area 320M and the auxiliary FPC 680. The integration chip 700 includes the gate voltage generator 750, the gray voltage generator 800, the data driver 500, and the signal controller 600 shown in FIG. 2.

A gray voltage generator 800 generates one set or two sets of gray voltages related to transmittance of the pixels. When two sets of the gray voltages are generated, the gray voltages in one set have a positive polarity with respect to the common voltage Vcom, while the gray voltages in the other set have a negative polarity with respect to the common voltage Vcom.

The data driver 500 is connected to the data lines D₁-Dₘ of the panel unit 300 via transmission gates TG₁-TG₆, and applies data voltages selected from the gray voltages supplied from the gray voltage generator 800 to the data lines D₁-Dₘ.

The signal controller 600 controls the gate driver 400 and the data driver 500.

Now, the operation of the display device will be described in detail referring to FIGS. 1 and 2.

The signal controller 600 is supplied with image signals R, G, and B and input control signals controlling the display of the image signals R, G, and B from an external device (not shown). The input control signals include, for example, a vertical synchronization signal Vsync, a horizontal synchronization signal Hsync, a main clock MCLK, and a data enable signal DE. After generating gate control signals CONT1, data control signals CONT2, and switching control signals CONT3 and CONT4 and processing the image signals R, G, and B to be suitable for the operation of the panel units 300M and 300S in response to the input control signals, the signal controller 600 provides the gate control signals CONT1 to the gate drivers 400M and 400S, the processed image signals DAT and the data control signals CONT2 to the data driver 500, and the switching control signals CONT3 and CONT4 to the transmission gates TG₁-TG₆ and first and second switching elements SW1 and SW2.

The gate control signals CONT1 include a vertical synchronization start signal STV for informing the gate driver of a start of a frame, a gate clock signal CPV for controlling an output time of the gate-on voltage Von, and an output enable signal OE for defining a width of the gate-on voltage Von.

The data control signals CONT2 include a horizontal synchronization start signal STH for informing the data driver 500 of a start of a horizontal period, a load signal LOAD or TP for instructing the data driver 500 to apply the appropriate data voltages to the data lines D₁-Dₘ, a data clock signal HCLK, and an inversion control signal RVS for reversing the polarity of the data voltages (with respect to the common voltage Vcom).

The switching control signals CONT3 and CONT4 control the transmission gates TG₁-TG₆ and the first and second switching elements SW1 and SW2, and have high and low levels.

The data driver 500 receives the processed image signals DAT for a pixel row from the signal controller 600, and converts the processed image signals DAT into the analog data voltages selected from the gray voltages supplied from the gray voltage generator 800 and applies the data voltages to the data lines D₁-Dₘ via the turned-on transmission gates TG₁-TG₆ in response to the data control signals CONT2 from the signal controller 600.

In response to the gate control signals CONT1 from the signal controller 600, the gate drivers 400M and 400S apply the gate-on voltage Von to the gate lines G₁-Gₙ, thereby turning on the pixel switching elements Q connected to the gate lines G₁-Gₙ.

The data driver 500 applies the data voltages to corresponding data lines D₁-Dₘ for a turn-on time of the pixel switching elements Q, which is called “one horizontal period” or “1H” and equals one period of the horizontal synchronization signal Hsync, the data enable signal DE, and the gate clock signal CPV. The data voltages in turn are supplied to corresponding pixels via the turned-on pixel switching elements Q.

The difference between the data voltage and the common voltage Vcom applied to a pixel is expressed as a charged voltage of the LC capacitor C_{LC}, i.e., a pixel voltage. The liquid crystal molecules have orientations depending on a magnitude of the pixel voltage, and the orientations determine a polarization of light passing through the LC capacitor C_{LC}. The polarizers convert light polarization into light transmittance.

By repeating the above-described procedure, all gate lines G₁-Gₙ are sequentially supplied with the gate-on voltage Von during a frame, thereby applying the data voltages to all pixels. When a next frame starts after finishing one frame, the inversion control signal RVS applied to the data driver 500 is controlled such that a polarity of the data voltages is reversed (“frame inversion”). The inversion control signal RVS may be controlled such that the polarity of the data voltages flowing in a data line in one frame is reversed (“row inversion”, “dot inversion”), or the polarity of the data voltages in one packet is reversed (“column inversion”, “dot inversion”).

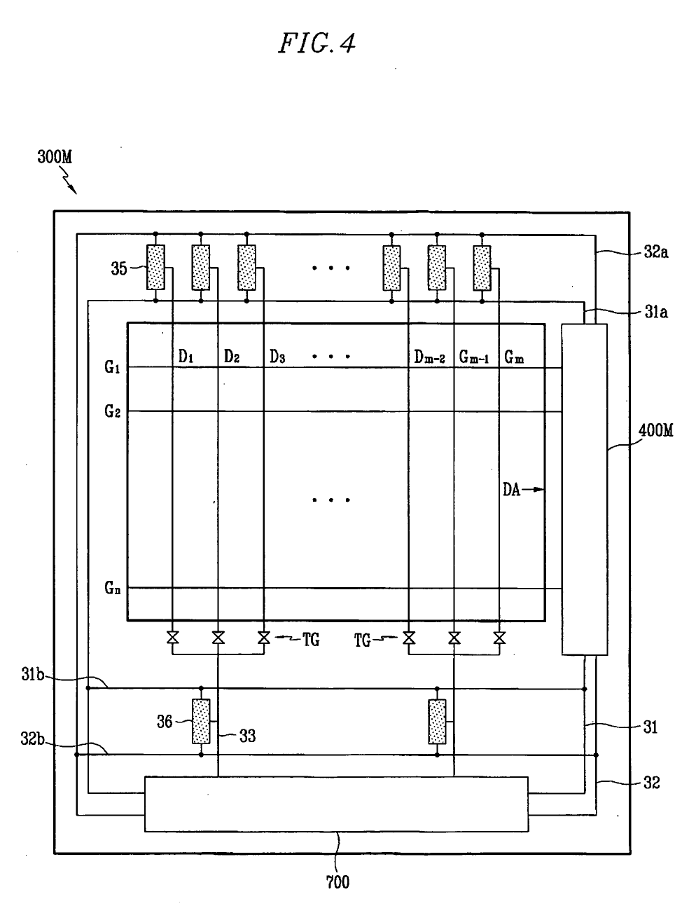

An LCD according to exemplary embodiments of the present invention will now be described in detail with reference to FIGS. 4-7.

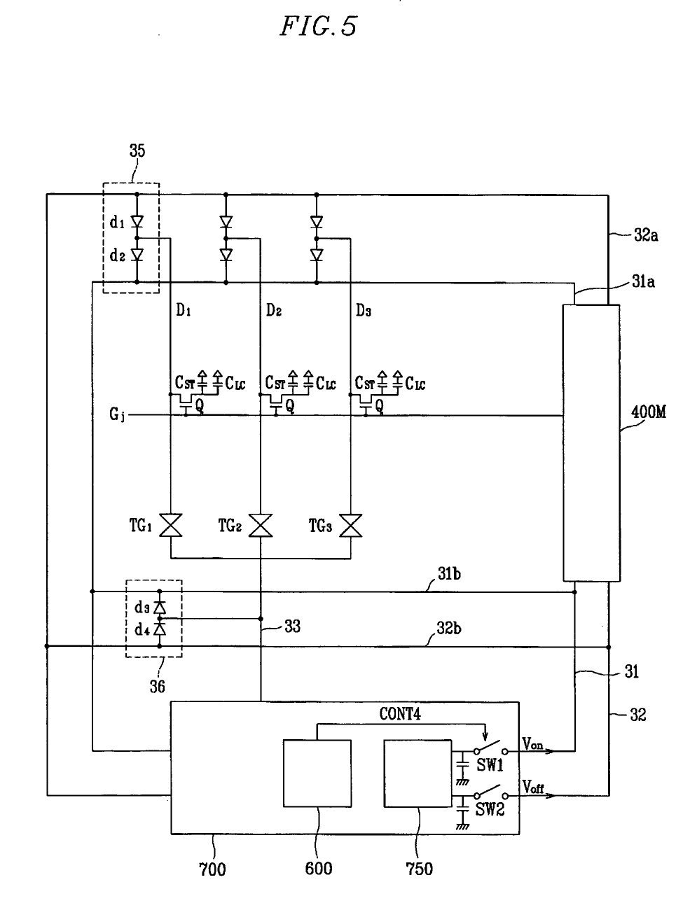

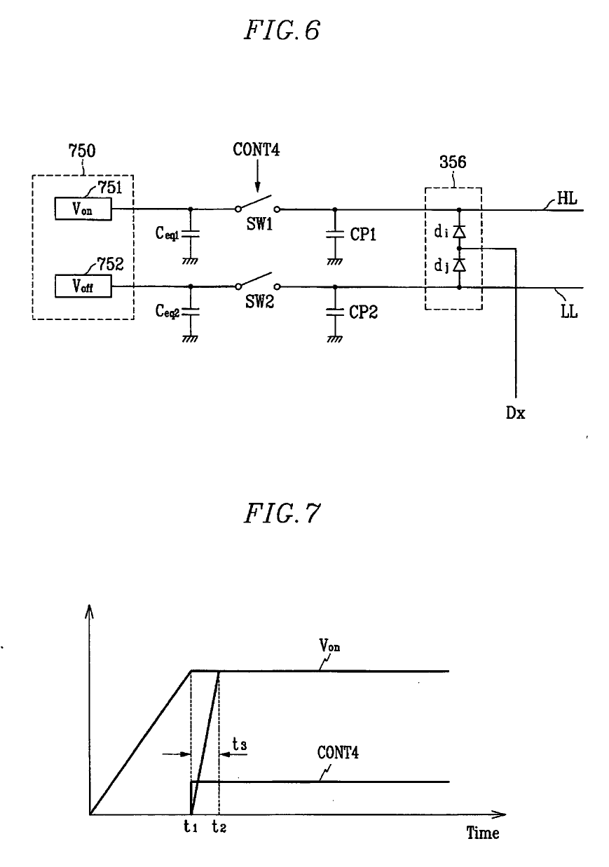

FIG. 4 shows a schematic view of an LCD according to an exemplary embodiment of the present invention, FIG. 5 shows a partially enlarged view of the LCD of FIG. 4, FIG. 6 shows an equivalent circuit diagram of a driving apparatus of an LCD according to an exemplary embodiment of the present invention, and FIG. 7 is a timing chart of a gate-on voltage and a switching control signal of a driving apparatus of an LCD according to an embodiment of the present invention.

The main panel unit 300M is shown in FIG. 4, which will be described as an example.

Referring to FIG. 4, the integration chip 700 is disposed at the lower side of the panel unit 300M, and the gate driver 400M is integrated in the right thereof. High voltage lines 31, 31a and 31b and low voltage lines 32, 32a and 32b are connected in a ring shape between the integration chip 700 and the gate driver 400M in a clockwise direction or in a counter clockwise direction at the peripheral area outside a display area DA.

The voltage lines 31 and 32 are connected between the integration chip 700 and gate driver 400M and the voltage lines 31a and 32a are connected therebetween in the counter clockwise direction and in the clockwise direction with respect to the integration chip 700, respectively. The voltage lines 31b and 32b are connected between the voltages lines 31 and 32 and the voltage lines 31a and 32a, respectively. The high voltage lines 31, 31a, and 31b are disposed in the inner side, the low voltage lines 32, 32a, and 32b are disposed in the outer side, and the high voltage lines 31 and 31a and the low voltage lines 32 and 32a are connected to each other via the gate driver 400M.

Each channel 33 of the integration chip 700 is connected to three transmission gates TG and each of the transmission gates TG is connected to one of the data lines D₁-Dₘ.

Additionally, diode units 35 and 36 are connected between two voltage lines 31a and 32a and two voltage lines 31b and 32b, respectively.

Referring to FIG. 5, the diode unit 35 includes a plurality of diodes d1 and d2 connected from the low voltage line 32a to the high voltage line 31a in a backward direction, and the diode unit also includes a plurality of diodes d3 and d4 from the low voltage line 32b to the high voltage line 31b in the backward direction.

In this case, the diode unit 35 is connected to the data lines D₁-Dₘ and the diode unit 36 is connected to the channels 33. The data lines D₁-Dₘ are connected between two diodes d1 and d2 and the channels are connected between two diodes d5 and d6.

In this way, currents do not flow from the high voltage lines 32a and 32b to the low voltage lines 31a and 31b, and an electrostatic charge is released via the data lines D₁-Dₘ or the channels 33 connected between the diodes d1 and d2 and the diodes d5 and d6, respectively, after penetration of the electrostatic charge into the center of the panel unit 300M.

Meanwhile, when power is supplied to the LCD, the gate voltage generator 750 begins to generate the gate-on voltage Von and the gate-off voltage Voff, which will now be described referring to FIGS. 6 and 7.

Hereinafter, a reference numeral denoted by ‘C’ represents a capacitor as well as a capacitance of the capacitor.

As shown in FIG. 6, the gate voltage generator 750 includes a gate-on voltage generator 751 and a gate-off voltage generator 752.

A high voltage line HL, which is denoted by ‘31’, ‘31a’, and ‘31b’ in FIGS. 4 and 5, and a low voltage line LL, which is denoted by ‘32’, ‘32a’, and ‘32b’ in FIGS. 4 and 5, are connected to the gate-on voltage generator 751 and the gate-off voltage generator 752, respectively. A diode unit 356 is connected between the high and low voltage lines HL and LL. The diode unit 356 includes two diodes di and dj in a backward direction. In this case, the diode unit 356 is one of the diode unit 35 and the diode unit 36, the diode di is one of the diodes d2 and d3, and the diode dj is one of the diodes d1 and d4. Additionally, the data line Dx is one of the data lines D₁-Dₘ.

The first switching element SW1 is connected to the high voltage line HL and the second switching element SW2 is connected to the low voltage line LL. A capacitor C_{eq1} has an end connected between the gate-on voltage generator 751 and the first switching element SW1 and another end connected to ground, and a capacitor C_{eq2} has an end connected between the gate-off voltage generator 752 and the second switching element SW2 and another end connected to ground.

The capacitor C_{eq1} holds an equivalent capacitance present between the gate-on voltage generator 751 and the first switching element SW1, and includes a capacitance present in the gate-on voltage generator 751 and a parasitic capacitance between the gate-on voltage generator 751 and the first switching element SW1.

Likewise, the capacitor C_{eq2} holds an equivalent capacitance present between the gate-off voltage generator 752 and the second switching element SW2, and includes a capacitance present in the gate-off voltage generator 752 and a parasitic capacitance between the gate-off voltage generator 752 and the second switching element SW2.

Additionally, capacitors CP1 and CP2 represent parasitic capacitances present in the high and low voltage lines HL and LL, respectively.

Referring to FIG. 7, when power is supplied to the LCD, for example, the gate-on voltage generator 751 begins to generate the gate-on voltage Von. At this time, a time t1 taken to reach a steady state, in which the gate-on voltage Von is constant, that is, a time t1 taken to full charge of the gate-on voltage Von is calculated by relation 1:
t₁=C_{eq}×Vₒₙ/I₁, (1)

where I₁ is a current flowing from the gate-on voltage generator 751 to the capacitor C_{eq1}.

When the first and second switching elements SW1 and SW2 are NMOS transistors, for example, the switching control signal CONT4 is a high level in a time ti such that the first switching element SW1 turns on, and thus the gate-on voltage Von charged in the capacitor C_{eq1} is charged to the capacitor CP1.

At this time, when the capacitor CP1 is fully charged in a time t₂, a time t₃ taken to full charge thereof corresponds to a difference of the two times t₁ and t₂, which is calculated by relation 2:
t₃=CP1×Vₒₙ/I₂, (2)

where I₂ is a current flowing from the capacitor C_{eq1} to the capacitor CP1.

In relations 1 and 2, two currents I₁ and I₂ are substantially identical because of transmitting the same voltage Von, and thus, the capacitances C_{eq1} and CP1 of the two capacitors determine the charge time. When the ratio of the two capacitances C_{eq1} and CP1 is about 100:1, the ratio of the two times t₁ and t₃ is also about 100:1. Adjustment of the ratio of the capacitances C_{eq1} and C_{eq2} and the parasitic capacitances CP1 and CP2 further adjusts the charge time.

Additionally, for the gate-off voltage Voff, the charge time is also calculated in the same manner as relations 1 and 2.

As above, provision of the first and second switching elements SW1 and SW2 between the gate voltage generator 750 and the voltage lines HL and LL decreases the charge time. For example, the charge time of the voltage lines HL and LL is the time t₁ without the first and second switching elements SW1 and SW2. Considering parasitic capacitances of the voltage lines HL and LL, the charge time is longer than the time t₁. As the charge time becomes longer, a time interval for applying a transient voltage to the diode unit 356 connected between the high and low voltage lines HL and LL also becomes longer. Thus, the transient voltage is divided by the diodes di and dj to be applied to the data lines D₁-Dₘ thereby displaying vertical stripes. In other words, a longer charge time induces an abnormal voltage to the data lines D₁-Dₘ to display the vertical stripes.

The first and second switching elements SW1 and SW2 are disposed between the gate voltage generator 750 and the voltage lines HL and LL, and the fully charged voltages are applied to the voltage lines HL and LL, thereby reducing the charge time as exemplified above. That is, a time interval when an abnormal voltage is induced to the voltage lines HL and LL is reduced significantly, and thus the vertical stripe fault or the horizontal stripe fault is decreased considerably.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

What is claimed is:

1. A driving apparatus for a liquid crystal display, comprising:
a signal line transmitting a gate voltage;
a gate voltage generator generating the gate voltage;
a switching unit disposed between the gate voltage generator and a gate voltage line; and
a signal controller generating a control signal for control of the switching unit.

2. The driving apparatus of claim 1, wherein the switching unit is turned on after the gate voltage reaches a steady state.

3. The driving apparatus of claim 2, further comprising:
a first capacitor having an end connected between the gate voltage generator and the switching unit and another end connected to a ground voltage; and
a second capacitor having an end connected to the signal line and another end connected to a ground voltage.

4. The driving apparatus of claim 3, wherein a capacitance of the first capacitor is greater than a capacitance of the second capacitor.

5. The driving apparatus of claim 4, wherein a ratio of the capacitance of the first capacitor and the capacitance of the second capacitor is more than about 100:1.

6. The driving apparatus of claim 1, wherein the gate voltage generator comprises a gate-on voltage generator generating a gate-on voltage and a gate-off voltage generator generating a gate-off voltage.

7. The driving apparatus of claim 6, wherein the signal line comprises a first voltage line transmitting the gate-on voltage and a second voltage line transmitting the gate-off voltage.

8. The driving apparatus of claim 7, wherein the switching unit comprises a first switching element connected to the gate-on voltage generator and a second switching element connected to the gate-off voltage generator.

9. The driving apparatus of claim 7, further comprising:
a first capacitor having an end connected between the gate-on voltage generator and the first switching element and another end connected to a ground voltage;
a second capacitor having an end connected between the gate-off voltage generator and the second switching element and another end connected to a ground voltage;
a third capacitor having an end connected to the first voltage line and another end connected to a ground voltage; and
a fourth capacitor having an end connected to the second voltage line and another end connected to a ground voltage.

10. The driving apparatus of claim 9, wherein the capacitances of the first and second capacitors are greater than a capacitance of the third capacitor and a capacitance of the fourth capacitor.

11. The driving apparatus of claim 10, wherein a ratio of the capacitance of the first capacitor to the capacitance of the third capacitor, and a ratio of the capacitance of the second capacitor to the capacitance of the fourth capacitor are more than about 100:1, respectively.

12. The driving apparatus of claim 11, wherein the first and second switching elements turn on after the first and second capacitors are charged.

13. The driving apparatus of claim 1, wherein the liquid crystal display comprises a panel unit provided with a plurality of pixels having gate lines and data lines connected thereto, which further comprises a driving circuit driving the panel unit.

14. The driving apparatus of claim 13, wherein the driving circuit comprises the switching unit.

15. A liquid crystal display comprising:
a plurality of pixels arranged in a matrix;
a panel unit provided with gate lines and data lines connected to the pixels;
a gate driver applying gate signals to the gate lines;
a driving circuit applying data voltages to the data lines;
a first voltage line;
a second voltage line;
a first diode unit including a first plurality of diodes connected between the first and second voltage lines;
a second diode unit including a second plurality of diodes connected between the first and second voltage lines;
a gate voltage generator generating a gate-on voltage and a gate-off voltage for applying to the gate driver via the first and second voltage lines, respectively; and
first and second switching elements connected between the gate voltage generator and the first voltage line, and the gate voltage generator and the second voltage line, respectively.

16. The liquid crystal display of claim 15, wherein an end of each of the data lines is connected between the first diode unit and another end thereof is connected to the second diode unit via one of a plurality of transmission gates.

17. The liquid crystal display of claim 16, further comprising a signal controller, a switching control signal thereof turning on/off the first and second switching elements.

18. The liquid crystal display of claim 17, wherein the gate voltage generator comprises a gate-on voltage generator generating the gate-on voltage and a gate-off voltage generator generating the gate-off voltage.

19. The liquid crystal display of claim 18, further comprising:
a first capacitor having an end connected between the gate-on voltage generator and the first switching element and another end connected to a ground voltage;
a second capacitor having an end connected between the gate-off voltage generator and the second switching element and another end connected to the ground voltage;
a third capacitor having an end connected to the first voltage line and another end connected to the ground voltage; and
a fourth capacitor having an end connected to the second voltage line and another end connected to the ground voltage.

20. The liquid crystal display of claim 19, wherein a capacitance of the first capacitor and a capacitance of the second capacitor are greater than a capacitance of the third capacitor and a capacitance of the fourth capacitor.

21. The liquid crystal display of claim 20, wherein a ratio of the capacitance of the first capacitor and the capacitance of the third capacitor is more than about 100:1.

22. The liquid crystal display of claim 21, wherein a ratio of the capacitance of the second capacitor and the capacitance of the fourth capacitor is more than about 100:1.

23. The liquid crystal display of claim 22, wherein the first and second switching elements turn on after the first and second capacitors are charged.

24. The liquid crystal display of claim 15, wherein the first and second diode units are connected in a backward direction.

25. The liquid crystal display of claim 24, wherein an end of each of the data lines is connected between the first diode unit and another end of each of the data lines is connected to the second diode unit via one of a plurality of transmission gates.

26. The liquid crystal display of claim 15, wherein the driving circuit comprises the gate voltage generator.

27. The liquid crystal display of claim 15, wherein the driving circuit comprises the first and second switching elements.

28. The liquid crystal display of claim 17, wherein the driving circuit comprises the signal controller.

29. The liquid crystal display of claim 15, further comprising:
a plurality of transmission gates connected between the data lines and the driving circuit.

30. The liquid crystal display of claim 15, wherein the first voltage line is disposed in a ring along an edge of the panel unit and the second voltage line is disposed in a ring along the edge of the panel unit and outer sides of the first voltage line.
